(19) United States
(12) Patent Application Publication
(10) Pub. No.: US 2009/0219956 A1
(43) Pub. Date: Sep. 3, 2009

(54) Device for Generating Narrowband Optical Radiation

(76) Inventors: Fredrik Laurell, Danderyd (SE); Bjorn Jacobsson, Stockholm (SE); Valdas Pasiskevicius, Lidingo (SE); Mikael Tiihonen, Vallingby (SE)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/917,227

(22) PCT Filed: Jun. 9, 2006
(86) PCT No.: PCT/SE2006/000681

§ 371 Date: Nov. 12, 2008

(30) Foreign Application Priority Data
Jun. 12, 2005 (SE) 0501437-8

(51) Int. Cl. H01S 3/10

(52) U.S. Cl. 372/20; 372/21

(57) ABSTRACT

Optical parametric generation is disclosed, wherein a bulk Bragg grating is used as an element for providing narrow wavelength bandwidth. Various embodiments for obtaining improved performance and narrow bandwidth operation are disclosed.

### TECHNICAL FIELD

The present invention relates to a device for generating narrowband optical radiation in an optical parametric process.

### TECHNICAL BACKGROUND

Parametric processes in optically nonlinear materials may be used for converting light or other electromagnetic radiation of one wavelength (the so-called pump) into light or other electromagnetic radiation of two other wavelengths (the so-called signal and idler). This may be performed in Optical Parametric Oscillators (OPOs), Optical Parametric Amplifiers (OPAs) or other devices for Optical Parametric Generation (OPG), where the second order nonlinearity of a nonlinear material is used. In order to obtain efficient conversion, the process should be phasematched. Phasematching may be provided by birefringent phasematching or by quasi-phasematching. By selecting the wavelength for the pump and by designing the phasematching properly, radiation may be produced of arbitrary wavelengths which are longer than the pump wavelength.

One problem of the radiation generated in the parametric process is that it is comparatively broadband. The bandwidth of the radiation could be made more narrow by introducing a wavelength selective element acting as a filter for the generated radiation. Previous wavelength selective elements which have been used for this purpose include plane surface gratings [see for example G. W. Baxter et al., Appl. Opt. 40 6659 (2001)]. However, one problem of this previous art is that losses are introduced into the system. In addition, such gratings are sensitive to high optical powers and may easily break.

Another type of grating that has been used is photorefractive Bragg gratings, which are created in bulk crystals. However, since these have severe stability problems, this approach has not yet gained practical applicability.

### DISCLOSURE OF THE INVENTION

One object of the present invention is to solve the problem of narrowing the bandwidth of optical parametric processes by utilizing a bulk Bragg grating that is permanently inscribed into a photosensitive glass, or alternatively a periodically ion-exchanged structure in a crystal.

In the first alternative, a periodic refractive index variation is inscribed into the glass, i.e. a Bragg grating, by means of a holographic technique known per se. The Bragg grating will then act as a wavelength selective filter reflecting radiation only within a narrow wavelength range. The wavelength of the reflected radiation, λ_{B}, is given by the Bragg condition:

λ_{B}=2mn₀Λ cos θ (1)

where Λ is the grating period, m is the order of the Bragg reflection, n₀ is the average refractive index of the glass and θ is the angle within the glass between the impinging radiation and the normal to the periodic grating structure. This type of bulk gratings in photosensitive glass has the advantage that it is comparatively small (in the order of millimeters), that it does not deteriorate over time and that it can withstand high optical powers. For the bulk glass Bragg grating, the index variation is sinusoidal, and hence the grating will only reflect the first order, m=1.

In the second alternative, using periodic ion-exchange, the refractive index variation is created in a crystal having a one-dimensional structure, where openings for the ion-exchange have been formed using a mask on the surface of the crystal. Examples of suitable crystals are the crystals of the KTP family, such as KTP, RTP, KTA, etc. Ion-exchange is normally performed by immersing the crystal in molten salt, e.g. RbNO₃ for KTP or KTA, or in KNO₃ for RTP and RTA. Due to the one-dimensional nature of the crystal and the ion-exchange, the refractive index profile will be changing step-wise for optical waves propagating perpendicular to this direction. Hence, the Bragg reflection can be obtained in higher orders, m=2, 3 etc.

According to the present invention, such Bragg grating is used as a wavelength selective filter in order to create narrowband radiation in optical parametric processes. One advantage of this type of wavelength selectivity in optical parametric processes is the stability of the bulk Bragg grating mentioned above, and the fact that the set-up may be made very compact due to the small size of the grating.

### BRIEF DESCRIPTION OF THE DRAWINGS

Embodiments of the invention will be described below with reference to the accompanying drawings, on which:

FIGS. 1-5 schematically show different set-ups for an inventive device;

FIG. 6 illustrate the line-narrowing effect obtained according to the invention; and

FIG. 7 shows how different signal wavelengths are obtained by tuning the angle of the grating.

### DETAILED DESCRIPTION OF PREFERRED EMBODIMENTS

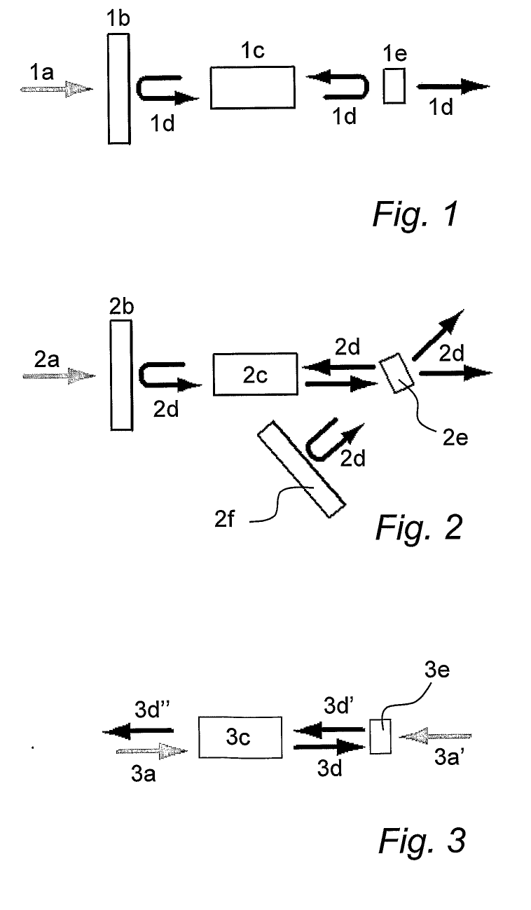

Examples of preferred set-ups for the inventive device are shown in FIGS. 1-5.

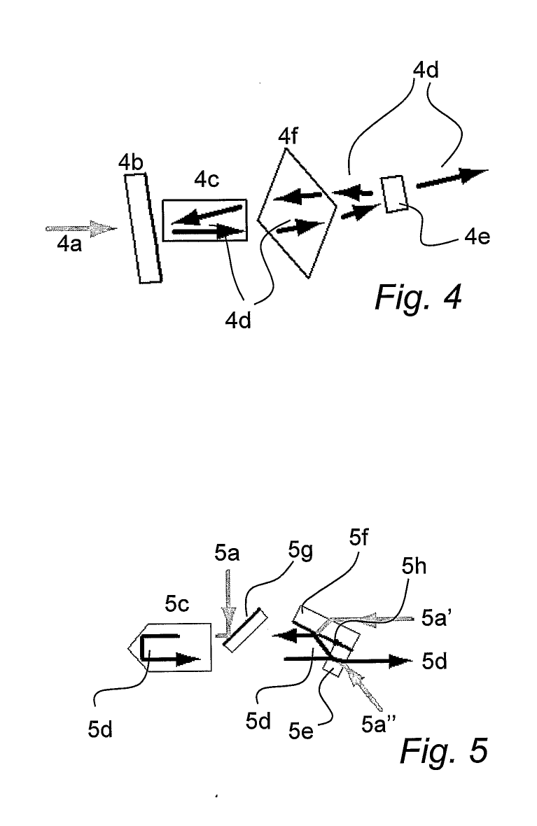

FIG. 1 schematically shows an optical parametric oscillator (OPO) according to a first embodiment, having a linear cavity which may be pumped (1a) from the left in the figure. The cavity is comprised by a first mirror (1b) reflecting the signal (1d) from the OPO, a nonlinear crystal (1c) where the wavelength conversion takes place, and a bulk Bragg grating (1e) selecting the signal wavelength within a narrow wavelength range and reflecting this back towards the first mirror (1b). Hence, the bulk Bragg grating (1e) acts as a second cavity mirror defining the resonant cavity. The signal may be coupled out from the cavity either through the mirror (1a) or through the Bragg grating (1e). This set-up has been successfully tested experimentally. FIG. 6 shows an example of how the wavelength of the OPO signal is narrowed (6a—solid line) compared to a situation where the cavity is defined by two regular mirrors (6b—dashed line). FIG. 6 also shows the reflectivity for the bulk Bragg grating used in the experiment (6c—dot-dash line). The horizontal axis in the figure shows the wavelength in nanometers, the left vertical axis shows the reflectivity for the bulk Bragg grating, and the right vertical axis shows the spectral density for the OPO signal in arbitrary units.

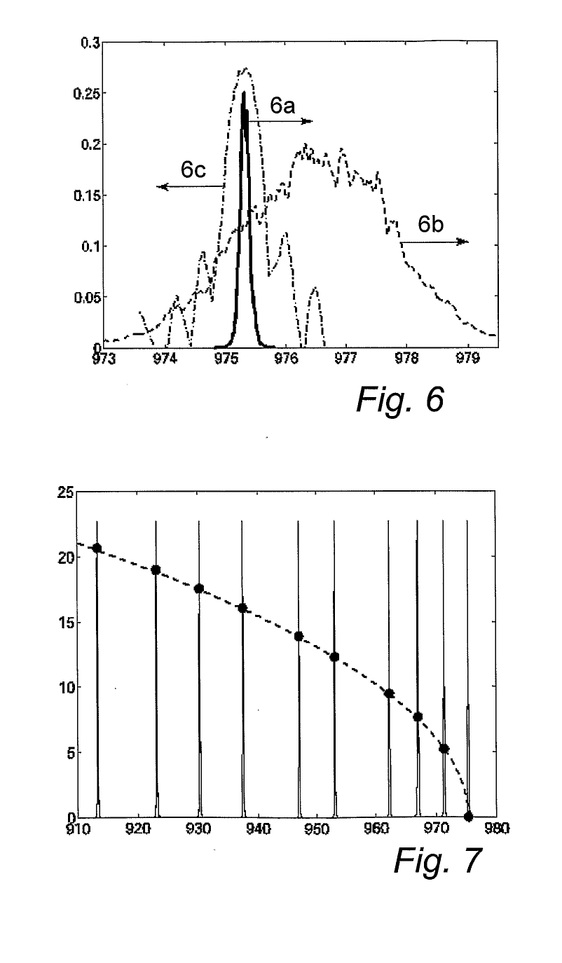

A second embodiment is schematically shown in FIG. 2. In this case, the OPO cavity is pumped from the left in the figure (2a), and is comprised of a first mirror (2b) reflecting the signal (2d) from the OPO, a nonlinear crystal (2c) in which the wavelength conversion takes place, a bulk Bragg grating (2e) selecting the wavelength of the signal within a narrow wavelength range, and finally a second mirror (2f) reflecting the signal back towards the first mirror (2b). By rotating the bulk Bragg grating (2e) with respect to the signal (2d), the Bragg grating will reflect different wavelengths according to equation (1), thus enabling generation of tunable radiation from this embodiment of the invention. The signal may be coupled out from the cavity either through the first mirror (2b), the bulk Bragg grating (2e) or through the second mirror (2f). As shown in FIG. 2, this embodiment has a folded cavity geometry, where the bulk Bragg grating acts as the folding mirror. This embodiment may facilitate the wavelength tuning. This embodiment has also been successfully tested experimentally. FIG. 7 shows how different signal wavelengths may be obtained by adjusting the angle of the grating. The horizontal axis of FIG. 7 shows the wavelength in nanometers, the left vertical axis shows the internal angle of incidence towards the grating, and the right vertical axis shows the spectral density in arbitrary units. The filled dots indicate experimental measurements for wavelength to angle of incidence. The dashed line shows the theoretical prediction for wavelength to angle of incidence according to equation (1), and the solid line shows the measured spectrum for the various measurements for wavelength to spectral density.

A third embodiment is schematically shown in FIG. 3. In this case, a nonlinear crystal (3c) is pumped (3a) and a signal (3d) is created by OPG. In the bulk Bragg grating, only a narrowband portion of this radiation (3d′) is reflected and amplified by means of a further pump (3a′) in a second pass through the crystal (3c), thus creating the amplified signal (3d″). Hence, FIG. 3 shows an optical parametric amplifier using the inventive concept to provide narrowband output.

A fourth embodiment is schematically shown in FIG. 4. In this case, the OPO has the shape of a ring cavity. The OPO is pumped (4a) from the left in the figure, where the cavity is comprised of a first mirror (4b) reflecting the signal (4d) from the OPO, a nonlinear crystal (4c) where the wavelength conversion takes place, a prism (4f) deflecting the signal such that it impinges under an angle towards a bulk Bragg grating (4e) selecting the wavelength of the signal to within a narrowband region and reflecting the same back through said prism (4f) and the nonlinear crystal (4c) towards the first mirror (4b). The signal may be coupled out either through the first mirror (4b), the grating (4e) or the prism (4f). By altering any angle of the components or the mutual distance between them, it is possible to obtain different angles of incidence towards the Bragg grating, and thus different wavelengths for the oscillating signal in accordance with equation (1). This set-up has successfully been tested experimentally and the wavelength of the signal has been tuned by simply altering the distance between the prism (4f) and the bulk Bragg grating (4e).

A fifth embodiment is schematically shown in FIG. 5. In this case, the OPO has the shape of a ring cavity which may be pumped from three different directions (5a, 5a′ or 5a″). The pump is incident into the nonlinear crystal (5c), in which the wavelength conversion takes place. The nonlinear crystal has one of its sides beveled to the shape of a retro-reflecting prism (indicated to the left in the figure), which by total internal reflection reflects back both the pump and the signal (5d). The cavity for the signal is comprised of, in addition to the nonlinear crystal (5c), a bulk Bragg grating (5e) into which the signal enters under an angle and in which the wavelength selectivity is effected; and a conventional mirror (5f) which reflects the signal back into the nonlinear crystal (5c). When pumping from direction (5a), an optional incoupling mirror (5g) is added, which is effective to reflect the pump into the nonlinear crystal (shown at 45 degrees incidence) and which transmits the signal. When pumping from direction (5a′), the mirror (5f) is made transmitting for the pump, while mirror (5f) is made reflecting for the pump when pumping from direction (5a′). Part of the signal is coupled out from the cavity through the bulk Bragg grating (5e) as output. By keeping the angle between the bulk Bragg grating (5e) and the mirror (5f) at 90 degrees, the signal (5d) impinging towards the grating (5e) will always be reflected back from the mirror (5f) in the opposite direction (180 degrees) compared to the incidence towards the grating (5e), regardless of the angle of incidence. However, the wavelength reflected by the grating (5e) will depend upon the angle of incidence according to equation (1). This means that the wavelength for the signal oscillating within the cavity may be tuned by rotating both the grating (5e) and the mirror (5f) simultaneously about an axis through their intersection (5h).

1. A device for optical parametric generation of coherent radiation, comprising: a first pump source for providing a pump beam; a nonlinear optical body operative to convert the pump beam into a signal beam and an idler beam in an optical parametric process; and a bulk Bragg grating positioned in a path of the radiation generated in said nonlinear optical body, for narrowing a bandwidth of the generated signal beam.

2. The device of claim 1, wherein the bulk Bragg grating is positioned such that it provides feedback for the generated signal beam through the nonlinear optical body, and further comprising a cavity mirror positioned on an opposite side of the nonlinear optical body such that it defines an optical parametric oscillator together with the bulk Bragg grating, said nonlinear optical body being positioned within the optical parametric oscillator.

3. The device of claim 1, wherein the bulk Bragg grating and the nonlinear optical body are separate physical elements.

4. The device of claim 1, further comprising a second pump source arranged in relation to the first pump source for providing amplification during passage of the signal beam in two opposite directions through the nonlinear optical body.

5. The device of claim 1, wherein the bulk Bragg grating is movable and/or rotatable in order to provide tunability for the wavelength narrowing capability of the device.

6. The device of claim 1, wherein the nonlinear optical body has a beveled side to the shape of a retro-reflecting prism, which by total internal reflection reflects back both the pump and the signal.

7. The device of claim 1, further comprising a prism for deflecting the signal beam such that it impinges under an angle towards the bulk Bragg grating, whereby tuning of the wavelength selectivity is obtained by altering either any angle of the components or the mutual distance between them.

8. The device of claim 1, wherein the nonlinear optical body is beveled to the shape of a retro-reflecting prism on one of its sides; and further comprising a mirror arranged in fixed relation with respect to the bulk Bragg grating; and wherein means are provided for rotating the mirror and the bulk Bragg grating simultaneously in order to adjust the angle of incidence of the signal beam towards said grating and to thereby provide wavelength tunability for the device; said mirror, said bulk Bragg grating and said retro-reflecting prism together forming a ring cavity in which the coherent radiation is generated.

9. The device of claim 1, wherein the bulk Bragg grating comprises a periodic refractive index variation inscribed into a glass body.

10. The device of claim 1, wherein the bulk Bragg grating comprises a refractive index variation created in a crystal by ion-exchange.

11. The device of claim 10, wherein the crystal is a crystal from the KTP family.
